(19) United States
(12) Patent Application Publication
(10) Pub. No.: US 2010/0138051 A1
(43) Pub. Date: Jun. 3, 2010

(54) METHOD AND ARRANGEMENT FOR ACTUATION

(75) Inventor: William H. Glime, Painesville, OH (US)

Correspondence Address: CALFEE HALTER & GRISWOLD, LLP, 800 SUPERIOR AVENUE, SUITE 1400, CLEVELAND, OH, 44114, US

(73) Assignee: SWAGELOK COMPANY, Solon, OH (US)

(21) Appl. No.: 11/995,334

(22) PCT Filed: Jul. 12, 2006
(86) PCT No.: PCT/US06/27438

§ 371 Date: Jan. 11, 2008

Related U.S. Application Data
(63) Continuation of application No. 60/698,889, filed on Jul. 13, 2005.
Application No. 60/698,889 is a continuation of application No. 60/750,452, filed on Dec. 14, 2005.

(51) Int. Cl. G05D 15/01; F16K 25/00; F16K 31/12; G05D 7/06; G05D 16/20

(52) U.S. Cl. 700/282; 251/157; 251/187; 251/58

(57) ABSTRACT

The present application relates to an arrangement for selectively providing a plurality of output forces, such as for example, a higher and a lower output force or a predetermined, time dependent output force. In one embodiment, a first piston assembly is moveable between a first and a second position and a second piston assembly moveable between a third and a fourth position. When the first piston assembly is in the first position, the second piston assembly is selectively movable between the third position and the fourth position. When the first piston assembly moves the second position, it moves the second piston assembly to the fourth position.

### RELATED APPLICATIONS

This application claims the benefit of U.S. provisional patent applications Ser. No. 60/698,889 for DUAL MODE ACTUATOR filed Jul. 13, 2005, and Ser. No. 60/750,452 for METHOD AND ARRANGEMENT FOR DUAL MODE ACTUATION filed Dec. 14, 2005, the entire disclosures of which are fully incorporated herein by reference.

### BACKGROUND OF THE INVENTION

Some processes may require a valve that actuates at a high cycle frequency. In other words, the valve opens and closes with a relatively small amount of time between opening and closing events. High frequency actuators are often used to actuate the valves in these applications. One process that utilizes high frequency actuators is atomic layer deposition (ALD). ALD is a process that utilizes actuators to open and close valves rapidly to deposit very thin layers of various reactive materials or chemicals on the surface of a substrate. A typical ALD process may require, for example, tens to hundreds of actuation cycles over the course of a few minutes before the final deposited layer is achieved. Once the layer is deposited, the substrate is removed, a new substrate is introduced, and the process is repeated.

Some processes may also require a valve with high integrity sealing (i.e. low through-valve-leakage). Through-valve-leakage refers to the amount of fluid (gas or liquid) that passes through a valve when the valve is in a closed or sealed position. In a valve that is closed by a seal formed by pressing two sealing members together, such as in a diaphragm valve, increasing the amount of force pressing the sealing members together generally reduces the through-valve-leakage. Thus, applications that desire high integrity sealing can be designed to utilize higher sealing forces. Applications where the valve remains closed for relatively long periods of time, such as during system maintenance or when the process is paused to change system parameters, benefit from low through-valve-leakage, and generally, rely on higher sealing forces to maintain the seal. Sealing members, however, are more prone to wear or damage when higher sealing forces are used, especially in high cycle frequency or extended cycle applications.

### SUMMARY OF DISCLOSURE

This disclosure relates generally a method and arrangement for actuation. One inventive concept disclosed in this application relates to an arrangement for selectively providing a plurality of output forces, such as for example, a higher and a lower actuation force or closing force. In one embodiment, the arrangement may include an actuator coupled to a flow control device, such as for example a valve, where the actuator may provide a higher actuation force or closing force as a first output and lower actuation or closing force as a second output. For example, during cycling, the arrangement may provide a first amount of force between sealing members when the valve is closed. During a sustained period of valve closure or during lower frequency cycling, however, the arrangement may provide for a second amount of force between sealing members, where the second amount of force is greater than the first amount of force.

Another inventive concept disclosed in the application relates to an arrangement having a multiple actuators that may be actuated independent of each other and/or may also work together to provide an actuation force. In one embodiment, a first actuator is movable between a first position and a second position in response to a first control signal and a second actuator is movable between a third position and a fourth position in response to a second control signal. When the first actuator is in the first position, the second actuator is selectively movable between the third and fourth positions. When the first actuator is in the second position, however, the first actuator moves the second actuator to the fourth position. In a more specific embodiment, the arrangement is coupled to an actuated device or flow control device, such as for example, a valve. Thus, fluid flow through the device may be controlled by moving a first actuator to a position where a second actuator freely opens and closes the device. In addition, the flow through the device may be controlled by moving the first actuator in a manner to force the second actuator to open and close the device.

Another inventive concept disclosed in the application relates to providing a predetermined, time dependent output force. In one embodiment, in a first mode of operation, a first amount of output force may be provided by an arrangement. In a second mode of operation, an offsetting actuation force may be provided to reduce the output force to a second level. Over a predetermined time, the offsetting actuation force may be removed. In a more specific embodiment, a pressure driven actuator provides an actuation force and an arrangement prevents complete depressurization of the actuator during one mode but allows for a slow release of pressure from the actuator in another mode.

Another inventive concept disclosed in the application relates to providing a first level of output force when operating a device at a first cycling frequency and providing a second level of output force when operating the device at a second cycling frequency. In one embodiment, an arrangement provides or allows for a lower output force when cycling at a higher frequency and provides for a higher output force when cycling at a lower frequency.

Further advantages and benefits will become apparent to those skilled in the art after considering the following description and appended claims in conjunction with the accompanying drawings.

### BRIEF DESCRIPTION OF THE DRAWINGS

In the accompanying drawing, which are incorporated in and constitute a part of the specification, embodiments of the inventions are illustrated, which, together with a general description of the inventions given above, and the detailed description given below, serve to exemplify embodiments of the inventions.

FIG. 1 is a schematic representation of a first exemplary embodiment;

FIG. 2 is a schematic representation of a second exemplary embodiment;

FIG. 3 is a cross-sectional view of a third exemplary embodiment;

FIG. 3A is a cross-sectional view of an alternate embodiment of a seal of the embodiment of FIG. 3;

FIG. 4 is a cross-sectional view of the embodiment of FIG. 3 in a first closed position;

FIG. 5 is a cross-sectional view of the embodiment of FIG. 3 in a second closed position;

FIG. 6 is a schematic representation of a fourth exemplary embodiment;

FIG. 7 a schematic representation of fifth exemplary embodiment; and

FIG. 8 a schematic representation of a sixth exemplary embodiment.

### DETAILED DESCRIPTION OF EXEMPLARY EMBODIMENTS

While the exemplary embodiments described herein are presented in the context of an arrangement including an actuator coupled to a normally-closed valve or an actuator actuated by biasing members and fluid pressure, those skilled in the art will readily appreciate that the present invention may be configured in other ways. For example, the arrangement may be configured to use a separate actuator coupled to an actuated device or have the actuating functionality integral with the actuated device. Further the arrangement may be configured to include different actuators, such as for example, a hydraulic actuator, different actuated devices, such as for example, a normally open valve or a device other than a valve. These examples and the disclosed exemplary embodiments are intended to illustrate the broad application of the inventions and are intended to provide no limitation on the present inventions.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

Terms suggesting direction and orientation, such as upper, lower, top, bottom, above, and below, are used herein merely for convenience of explanation when referencing the figures and are not intended to form structural or use limitations or references for the invention.

Referring to FIG. 1, generally, an arrangement 1 may include an actuator 2, which in response to a control function 4 may selectively provide or allow for a first output 6 and a second output 8. The outputs 6, 8 may be, for example, different amounts of actuation force, or different amounts of closing force if a valve is coupled to or integral with the actuator 1.

In accordance with one inventive aspect, higher actuation forces may be provided during prolonged valve closure for low through-valve-leakage and lower actuation forces may be provided during higher-frequency actuation for faster actuation speed, reduced component wear, lower particle generation and longer valve lifetimes. Arrangements that can deliver higher frequency actuation under lower actuation forces in one mode and low through-valve-leakage under higher actuation forces in a second mode may improve processes that benefit from both modes.

An example of a process that may benefit from both modes is ALD. During high frequency actuation, the ALD process can typically tolerate a higher level of through-valve-leakage than during system maintenance or when the process is in a standby mode where a low through-valve-leakage is desired. Thus, an arrangement that can deliver low through-valve-leakage under higher actuation forces combined with high frequency actuation performance under lower actuation forces offers an improved solution for ALD and other applications. ALD, however, is merely a specific example of a process that may benefit from the disclosed arrangement. One of ordinary skill in the art will appreciate that the arrangement disclosed herein may be used in many other applications and processes.

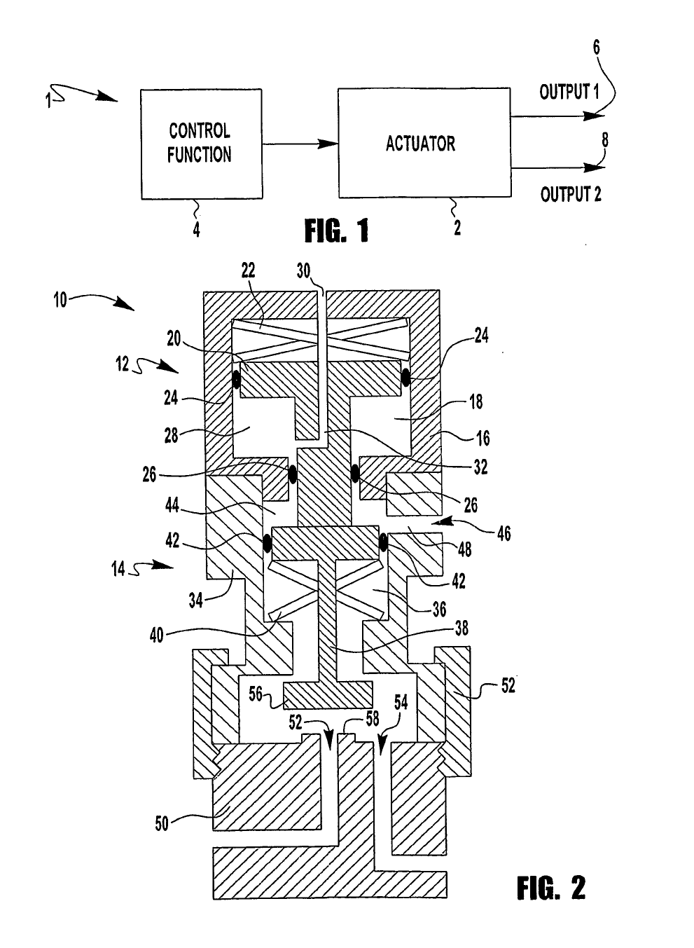

FIG. 2 illustrates a schematic representation of an exemplary embodiment of an arrangement according to the principles of the present invention. The arrangement may be realized as an actuator 10 having a higher force actuator assembly 12 and a lower force actuator assembly 14. The higher force actuator assembly 12 may include a housing 16 defining a compartment 18, a piston assembly 20 slideably disposed within the compartment, and a biasing element 22 disposed above the piston assembly 20. The biasing element 22 may be a spring or other suitable means for engaging and biasing the piston 20 downward. Sealing elements 24, 26, such as for example o-rings, may be provided to seal the area of the compartment 18 below the piston 20 to form a first pressurizable chamber 28. A fluid inlet 30 and a fluid path 32 provide access for pressurizing the chamber 28.

The lower force actuator assembly 14 may be coupled to the higher force actuator assembly 12. This embodiment illustrates the actuator assemblies 12, 14 in a linear configuration; however, this illustration is exemplary and the actuator assemblies may be configured in a variety of ways. The lower force actuator assembly 14 includes a housing 34 defining a compartment 36, a piston 38 slideably disposed within the compartment, and a biasing element 40 disposed below the piston 38. Sealing elements 26, 42 may be provided to seal the area of the compartment 36 above the piston to form a second pressurizable chamber 44. A fluid inlet 46 and a fluid path 48 provide access for pressurizing the chamber 44.

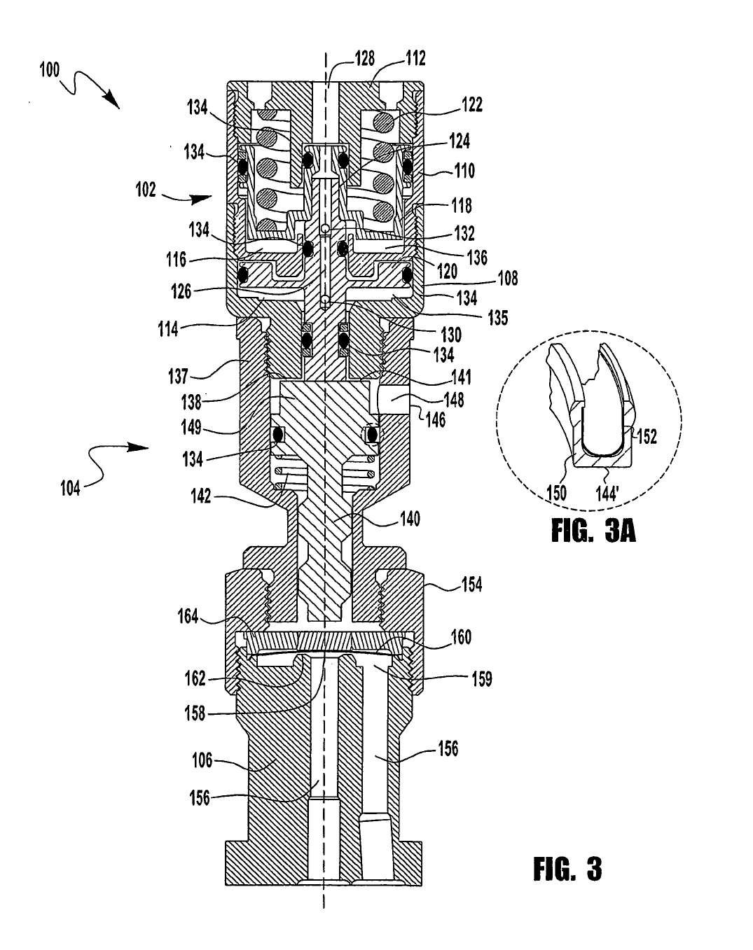

The lower force actuator assembly 14 may be coupled to an actuated device, such as for example a valve or valve body 50 by suitable means, such as a bonnet nut 52. The valve body 50 includes an inlet port 52 and an outlet port 54. Fluid flow through the valve 50 is controlled by a sealing arrangement comprising a sealing member 56 and a valve seat 58. The sealing member 56 may be coupled to the piston 38 in the low force actuator assembly 14 and positioned above the valve seat 58, which is located proximate to the inlet port 52. In this exemplary embodiment, the sealing member 56 is a sealing block. Other sealing members, however, may be used, such as for example a diaphragm as shown in the exemplary embodiment of FIGS. 3-5.

The actuator 10 may perform in two modes. In a first mode, the first pressurizable chamber 28 in the higher force actuator 12 may be pressurized to move the higher force actuator to a first position, out of engagement with the lower force actuator 14. This allows the lower force actuator 14 to open and close the valve 50 by selectively pressurizing the second pressurizable chamber 44 in the lower force actuator. Thus, in an exemplary embodiment, the pressure signal to the first and second pressurizable chambers 28, 44 may be independent of each other allowing the higher force actuator 12 to be held in the first position while the lower force actuator 14 cycles between the third and fourth positions.

In a second mode, the pressure in the first pressurizable chamber 28 is removed allowing the biasing element 22 to force the higher force piston assembly 20 to a second position, which engages the lower force piston assembly 38. Because the force applied by the biasing element 22 of the higher force actuator assembly 12 exceeds the force applied by the biasing element 40 of the lower force actuator assembly 14, the higher force piston assembly 20 may work through the lower force piston assembly 38 to selectively open and close the valve 50. Thus, cycling the pressure signal to the first pressurizable chamber 28 may cycle the valve 50 independent of any pressure signal to the second pressurizable chamber 44. Pressure in the second pressurizable chamber 44, however, may be used to provide additional actuation force to the valve 50. The arrangement 10 illustrated in FIG. 2 is arranged such that the valve 50 closes when the low force actuator moves to the fourth position. The arrangement 10 and/or valve 50 may, however, be configured otherwise, such as for example, the valve opening upon receiving an output force from the actuators 12, 14.

FIGS. 3 through 5 illustrate another exemplary embodiment. The actuator 100 is generally similar to the actuator 10 of FIG. 2 in that it includes a higher force actuator assembly 102 coupled to a lower force actuator assembly 104, which is coupled to an actuated device, such as a valve 106 or other flow control device. Though the exemplary embodiment illustrates the actuator 100 including two actuator assemblies 102, 104, one of ordinary skill in the art will appreciate that additional assembly may be added, such as a third, fourth or so on.

The higher force actuator assembly 102 illustrated in the exemplary embodiment of FIGS. 3-5 is disclosed in detail in U.S. patent application Ser. No. 11/143,411 for FLUID ACTUATOR filed Jun. 1, 2005, the entire disclosure of which is fully incorporated herein by reference. Therefore, the higher force actuator assembly 102 will only be generally discussed herein. The higher force actuator assembly 102 may include a lower housing 108, an upper housing 110, and a cap 112. The upper housing 110 may be assembled with the lower housing 108 such that the lower housing and the upper housing define a lower compartment 114. The cap 112 may be assembled with the upper housing 110 such that the upper housing and the cap define an upper compartment 116.

A first piston 118 is movably disposed in the lower compartment 116 and a second piston 120 is movably disposed in the upper compartment 116 against the bias of a biasing element, which may be realized as a spring 122. The pistons 118, 120 are joined such that they may move as a one-piece higher force actuator piston 124.

A fluid passage 126 is in fluid communication with a fluid inlet 128 located in the cap 112. The passage 126 allows pressurized fluid into the lower and/or upper compartments 114, 116 below the pistons 120, 118 via ports 130 and 132. The pressurized fluid acts on the pistons 118, 120 to drive them from a first or closed position, upward against the force of the spring 122, toward a second or open position.

Sealing elements 134 may be provided on the pistons 118, 120 to form sliding seals between the pistons and the housings 108, 110. The sliding seals allow the areas of the compartments 114, 116 below the pistons 118, 120 to form pressurizable chambers 135, 136 by restricting the pressurized fluid from leaking into undesirable areas and adversely affecting actuator performance.

The lower force actuator assembly 104 is coupled to the higher force actuator assembly 102, by suitable means, such as for example, by a threaded connection. The lower force actuator assembly 104 includes a housing 137 forming a piston compartment 138. A lower force actuator piston 140 is movably disposed in the piston compartment 138. A biasing element 142, which may be realized as a spring, is disposed below the piston 140 for biasing the piston upward.

A fluid port 146 and fluid passage 148 allows pressurized fluid into the compartment 138 above the piston assembly 140. A seal 144, such as for example an o-ring, may be associated with the lower force piston 140 to form a sliding seal between the piston and the housing 136. The seal 144 cooperates with a sealing element on the higher force piston assembly 124 allowing an area of the compartment 138 above the lower force piston assembly 140 to form a pressurizable chamber 141.

The upper portion 149 of the lower force piston assembly 140 consumes much of the volume of the pressurizable chamber 141. This enables the pressure in the chamber 141 to build rapidly, resulting is rapid actuation of the lower force piston assembly 140 when desired.

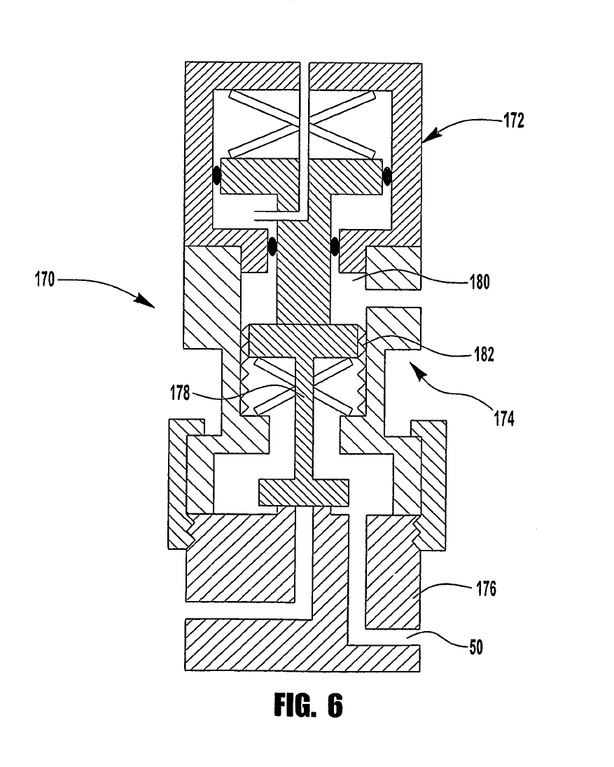

FIG. 3A an alternative embodiment of a seal for lower force piston assembly 140. The seal 144 in FIG. 3 is illustrated as an o-ring. The seal 144′ in FIG. 3A is illustrated as an spring energized seal. As is known in the art, the spring energized seal 144′ may include an outer seal material 150, such as for example a PTFE, an elastomer, a thermoplastic, or other polymeric component. The outer seal material 150 may be energized by a metal spring, elastomeric o-ring or other similar biasing means 152. Seals other than o-rings or spring energized seals may be used for seal 144′. For example, in the exemplary embodiment of FIG. 6, a bellows-type seal element is employed.

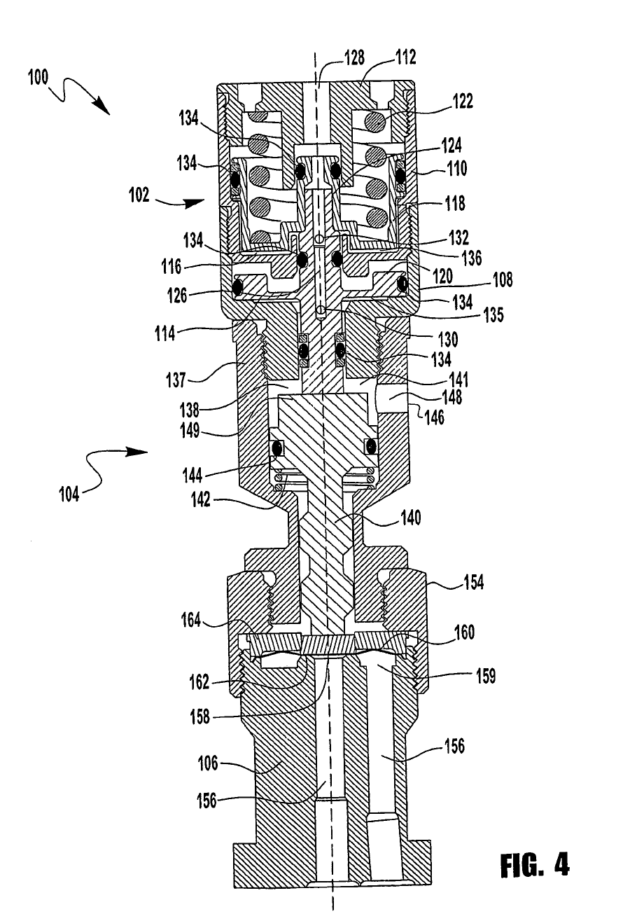

The valve body 106 may be assembled with the lower force actuator assembly 104 by a bonnet nut 154 or other suitable means. The valve body 106 defines a flow path 156 with an inlet port 158 and an outlet port 159. A sealing arrangement comprising a sealing member 160 and the valve seat 162 controls fluid flow through the valve body 106. The sealing member 160 in the exemplary embodiment of FIGS. 3-5 is realized as a diaphragm. The diaphragm 160 may be clamped between the lower force actuator assembly 104 and the valve body 106 via the bonnet nut 154 and a bonnet 164, as is known in the art. A button 166 may be coupled to the lower force actuator piston 140 to move the diaphragm 160 in and out of contact with the valve seat 162. The pistons assemblies 124, 140 generally move in the same manner as described for the exemplary embodiment of FIG. 2. However, since the natural shape of a diaphragm 160 is a domed shape (as best seen in FIG. 3), when the diaphragm 160 is deformed to seal against the valve seat 162 (as best seen in FIG. 4) the diaphragm 160 may exhibit elastic properties that bias the diaphragm 160 toward to its natural domed shape. These elastic properties can produced a force on the lower force actuator piston 140 that helps to move the piston towards its uppermost position. As the pressurizable chamber 141 above the lower force actuator piston 140 is depressurized, the force added by the diaphragm 160 can create faster response time for moving the lower force actuator piston, thus producing a faster opening of the valve flow path 156.

Although the actuator assemblies 102, 104 and valve body 106 are described and shown as coupled together or assembled by a bonnet nut, any method that secures the components relative to one another is possible. This includes direct and indirect methods. For example, an arrangement where the higher force actuator assembly 102 and lower force actuator assembly 104 are each secured to a common component positioned between the actuator assemblies 102, 104, is possible.

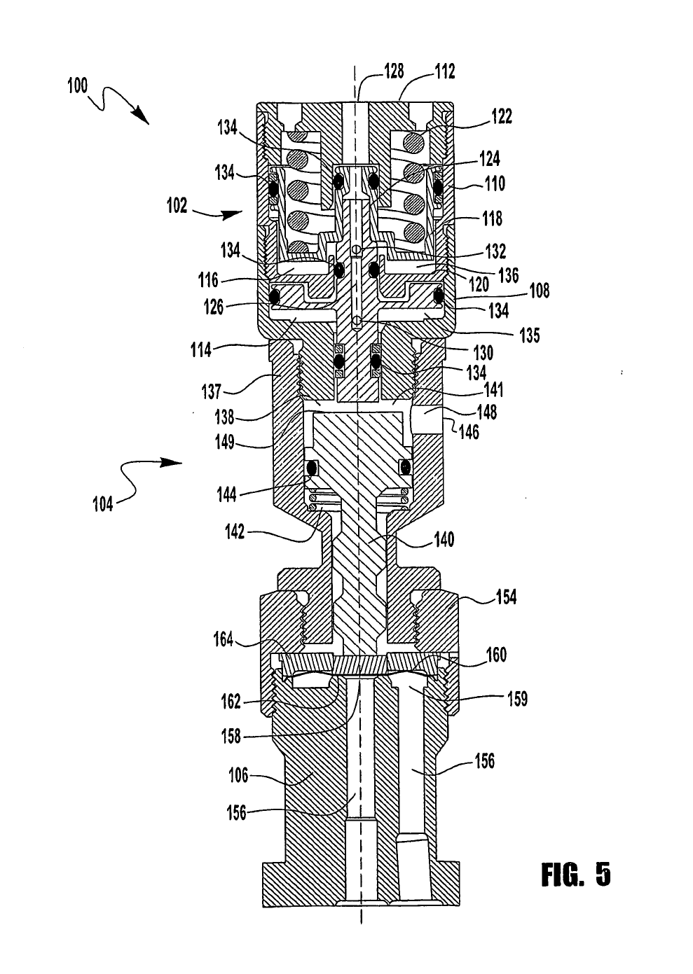

The actuator 100 may perform in two modes and the piston assemblies 124, 140 may move between two positions. The higher force actuator piston assembly 124 may move between a first position and a second position. The lower force actuator piston assembly 140 may move between a third position and a fourth position. FIG. 3 shows both piston assemblies 124, 140 in the uppermost positions, FIG. 4 shows both piston assemblies in the lowermost positions, and FIG. 5 shows the higher force actuator piston assembly in its uppermost position and the lower force actuator piston assembly in its lowermost position. The position of the assemblies 124, 140 are controlled by forces directed to the piston assemblies by the bias elements 122, 142 and by fluid pressure within the pressurizable chambers 135, 136, and 141.

The spring 122 of the higher force actuator assembly 102 exerts a force on the higher force actuator piston assembly 124 that biases the assembly towards its lowermost position. Pressurizing the chambers 135, 136 below the piston assembly 124 can counteract the spring force. The pressure biases the piston 124 towards its uppermost position against the bias of the spring 122. The fluid channeled into a pressurizable chambers 135, 136 may be air, but can be any fluid, including liquids. The lower force actuator assembly 104 may perform in a similar manner. In the illustrated lower force actuator assembly 104, the spring 142 resides below the lower force piston 140 and, thus, biases the piston assembly 140 towards its uppermost position. Fluid pressure in the chamber 141 above the lower force actuator piston assembly 140 biases the piston assembly towards its lowermost position.

Referring specifically to FIG. 3, both piston assemblies 124, 140 are shown in their uppermost position. The higher force actuator piston assembly 124 is at this position because the force applied to the assembly by pressurizing the chambers 135, 136 overcomes the bias force applied by the spring 122. The lower force actuator piston 140 is at this position because the force exerted on the piston assembly 140 by the spring 142 is greater than the force applied to the assembly by fluid pressure in the chamber 141, which may be depressurized. When the actuator 10 is in the position shown in FIG. 3, the flow path 156 is open and fluid may flow through the valve body 106.

Referring specifically to FIG. 4, both piston assemblies 124, 140 are shown in their lowermost position. The higher force actuator piston assembly 124 is at this position because the force applied by the spring 122 is greater than the force applied to the assembly by the fluid pressure in the pressurizable chambers 135, 136, which may be depressurized. The lower force actuator piston assembly 140 is in this position because the higher force actuator piston assembly 124 is biased by the spring 142 to engage the lower force actuator assembly and move it to its lowest position. Thus, the bias force applied the spring 122 overcomes the bias force applied by the spring 142. If the pressurizable chamber 141 above the lower force actuator piston assembly 140 is pressurized, the lower force actuator piston assembly 140 would be further forced to its lowermost position by the pressure in the chamber 141. When the dual mode actuator 100 is in the position shown in FIG. 4, the sealing member 160 moves into engagement with the valve seat 162 and flow through the valve body 106 ceases. Since the higher force actuator 102 is working through or in cooperation with the lower force actuator 104 to create a higher sealing force, the seal created between the diaphragm 160 and the valve seat 162 may result in low through-valve-leakage.

Referring to FIG. 5, the higher force actuator piston assembly 124 is in its uppermost position and the lower force actuator piston assembly 140 is in its lowermost position. The higher force actuator piston assembly 124, when held in its uppermost position by the pressure in the chambers 135, 136 does not interact or interfere with movement of the lower force actuator piston 140. Therefore, the lower force actuator piston assembly 140 may selectively engage and disengage the sealing member 160 and the valve seat 162 when the chamber 141 above the assembly is pressurized and depressurized. Thus, pressure applied to the lower force actuator piston assembly 140 from the pressurizable chamber 141 moves the diaphragm 160 into contact with the valve seat 162 independent of the higher force actuator 102. The relatively low spring force of the spring 142 and the configuration of the lower force piston assembly 140 facilitates rapid movement of the assembly when the chamber 141 above the lower force actuator piston is pressurized and depressurized.

In an exemplary embodiment, the chamber 141 may be pressurized and depressurized so that the valve opens and closes within approximately 20 milliseconds of a command signal being issued, for example. This allows the dual mode actuator 100 to perform as a high frequency actuator, which in turn allows the dual mode actuator 100 to perform ALD and similar processes. Since pressures are relatively low and the pneumatic piston area on which the pressure acts is relatively small, low sealing forces occur. Due to rapid cycling, valve components may experience elevated temperatures; however, the low sealing forces minimizes damage and deformation to components, such as the sealing member 160 or valve seat 162, which can extend the service life of a valve. In addition, the low sealing forces are less likely to cause particle generation due to wear on valve components, such as the sealing member 160 and valve seat 162.

On occasions when higher force seals are needed, the higher force actuator piston assembly 124 may be moved to its lowermost position and engage the sealing member 160, through the lower force actuator piston assembly 140, to form a higher force seal between the sealing member 160 and the valve seat 162, which can produce low through-valve-leakage. The higher force actuation piston assembly 124 can be moved to its lowermost position by decreasing or eliminating the pneumatic pressure in the chambers 135, 136 below the pistons 118, 120. This allows the spring 122 to move the higher force actuation piston assembly 124 to create a higher force seal between the sealing member 160 and the valve seat 162.

Actuators have been characterized as higher force and lower force. For example, but not limited to, a higher force actuator may deliver approximately 50 lbs. or greater of force to the valve seat, whereas a lower force actuator may deliver approximately 50 lbs. or less of force to the valve seat. In an exemplary embodiment, the higher force actuator delivers approximately 70 lbs. of pressure to the valve seat and the lower force actuator delivers approximately 20 lbs. of pressure to the valve seat.

Another characteristic of the arrangement, as shown in FIGS. 3 through 5, is that the normal or default position of the dual mode actuator 100 closes the flow path 156. If a failure occurs in the air supply, the spring 122 of the higher force actuator assembly 102 applies a force that moves the higher force actuator piston assembly 124 into the lowermost position, which seals or closes the flow path 156 through the valve body 106. This reduces the possibility of allowing undesired flow through the valve body 106 due to a system failure.

FIG. 6 schematically illustrates another exemplary embodiment of the arrangement realized as a dual mode actuator 170. The actuator 170 is substantially similar to the actuator 10 of FIG. 2 in that it includes higher force actuator 172 coupled to a lower force actuator 174, which is coupled to a valve body 176. The lower force actuator 174 includes a piston assembly 178 slideably disposed within a piston compartment 180.

In this embodiment, however, the seal element 42 (as shown in FIG. 2) is realized as a bellows 182. The bellows 182 seals the area of the compartment 180 above the piston assembly 178 and extends below the upper portion of the piston 178. Although the main purpose of the bellows 182 is to seal the area of the compartment 180 above the piston 178, the bellows 182 is attached to the piston such that it compresses as the piston moves from its uppermost position to its lowermost position. The bellows 182 typically has elastic properties that urges the bellows to return to its natural position. These elastic properties create a upward force on the lower force actuation piston assembly 178 that moves the piston assembly towards its uppermost position. Thus, similar to the diaphragm 160 of FIGS. 3-5, the bellows 182 may create a faster response time for opening the valve 176. In addition, the bellows 182 may be constructed of metal, which makes it less susceptible to damage or deformation due to heat generated during high frequency actuation.

Although the descriptions and illustrations provided for these embodiments show sealing arrangements that include sealing blocks 56 and diaphragms 160 as sealing members, any component or method that is capable of opening or closing a valve is considered a sealing arrangement for the scope of this invention. Furthermore, the arrangements 10, 100 and 170 have been shown with spring and pneumatic forces controlling the movement of the pistons. These methods of moving the pistons are exemplary only and do not limit the invention in any way. Any structure or method that moves the pistons between two positions is incorporated herein. For example, the springs can be replaced by additional pressurizable chambers to apply forces onto the pistons. In another example, springs can be positioned below the higher force actuator piston and a pressurizable chamber can be disposed above the piston. Similarly, a spring can be positioned above the lower force actuator piston and a pressurizable chamber can be disposed below the piston. Further, the arrangement embodiments 10, 100, 170 include a higher force actuator linearly connected lower force actuator for transferring force linearly between the actuators and to an actuated device. The arrangement, however, may be configured in a non-linear manner or transfer force non-linearly, such as for example in a manner to include rotation motion or force being transferred.

FIG. 7 illustrates a schematic of another exemplary embodiment of an arrangement according to the principles of the present invention. In this embodiment, the arrangement 200 may include an actuator 202 coupled to an actuated device 204 for operating the device 204 in response to an input 206. The actuated device 204, may be for example, a normally-closed diaphragm valve, similar to the valve 106 in FIGS. 3-5. The actuated device 204, however, may be any device operated by the actuator 202 where time dependent application of force is desired, such as for example, a time dependent sealing force between sealing members of a valve or a time dependent actuation force from an actuator. The actuator 202 may be for example a dual piston actuator similar to the higher force actuator assembly 102 in FIGS. 3-5. The actuator 202, however, may be any device capable of delivering or being controlled to deliver a time dependent actuation force.

The input 206 may be realized as a pressure source that is fluidly coupled to the actuator 202 to provide the requisite pressure signal to operate the actuated device 204. A switching device 208, such as for example, a solenoid pilot valve, is positioned in-line between the pressure source 206 and the actuator 202. The switching device 208 can switch between a first position 210 in which the pressure source 208 is placed in fluid communication with the actuator 202 and a second position 212 in which the pressure source 206 is fluidly isolated from the actuator 202 and the actuator is placed in fluid communication with a vent path 214.

A pressure retention device 216, such as for example, a relief valve or a check valve with a preset or user adjustable cracking pressure, is included in the vent path 214. A leak or bypass path 218 is also included in the arrangement. In the exemplary embodiment of FIG. 7, the pressure retention device 218 may consist of a check valve design and the leak path 218 may consist of a calibrated leak at the check valve's sealing members or a line which bypasses around the check valve, both of which enables the slow dissipation of pressure from inside the actuator 202.

The pressure retention device 216 may have various configurations and be located in a variety of locations. For example, the pressure retention device 216 may be integral to the actuator 202, integral to the switching device 208, or installed as a separate component that is located between the switching device 208 and actuator 202, after the switching device 208, or some other suitable location. In the exemplary embodiment in FIG. 7, the pressure retention device 216 is installed in the vent path 214, downstream of the switching device 208. This embodiment achieves the desired result without the need for additional components.

For the exemplary example in FIG. 7, in operation, when the switching device 208 is in the first position 210, the pressure source 206 is in fluid communication with the actuator 202. As a result, a pressure signal from the pressure source 206 may allow the actuator 202 to open the valve 204, against the bias of a biasing element, such as a spring 220, for example. When the switching device 208 switches to the second position 212, the pressure source is no longer in fluid communication with the actuator 202. Instead, the actuator 202 is placed in fluid communication with the vent path 214 such that pressure in the actuator from the pressure signal may be released via the vent path. Releasing pressure in the actuator 202 allows the valve 204 to move to a closed position under the bias of the biasing element 220. Thus, moving the switching device 208 between the first and second positions 210, 212 cycles the valve 204 between an open position and closed position, respectively. In a high cycling frequency operation, such as ALD, the valve 204 cycles frequently, such as for example, 20 cycles per minute.

While cycling, the pressure retention device 216 in the vent path 214 limits the amount of pressure released from the actuator 202. As an example, if the pressure source 206 supplies approximately 70 psi to the actuator 202 and the pressure retention device 216 consists of a check valve with a cracking pressure of about 30 psi, then when the switching device 208 moves to the second position 212, the pressure retention device 216 is exposed to the approximately 70 psi in the actuator 202. The pressure in the actuator 202 causes the pressure retention device 216 to open allowing the pressure to release. When, however, the pressure drops to approximately 30 psi, the pressure retention device 216 closes, preventing any additional pressure to release through the device. As a result, approximately 30 psi is retained in the actuator 202. The retained pressure in the actuator 202 works against or offsets some of the bias or closing force from the biasing element such that the sealing force on the sealing members of the valve 204 is less that the full sealing force the bias element can deliver. The actual amount of the force from the biasing member and the actuator are at the user's discretion and can be adjusted and customized by, for example, changing the cracking pressure of the pressure retention valve 216 or the bias force of the biasing element.

Thus, when the valve 204 is cycling quickly (e.g. 1 cycle per second), the sealing force is relatively low (e.g. 20 lbs.). As a result, the retained pressure in the actuator 202 reduces the delivered sealing force between the sealing members, which reduces the likelihood of seal damage and particle generation associated with high-speed actuation and higher sealing forces, thus extending the life of the valve.

The leak path 218 is configured such that even when the pressure retention device 216 is closed to prevent pressure releasing through the device, pressure can relieve via the leak path 218, albeit at a slower rate. As a result, if the valve 204 is maintained in a closed position for a period of time greater than would be expected during high cycle frequency operation, such as for example 30 seconds, the pressure retained in the actuator 202 by the pressure retention device 216 will release via the leak path 218. The rate of pressure release can be customized or adjusted based on the configuration of the leak path 218. For example, if the leak path 218 is configured as a path open to atmosphere, the relative size of the path can determine the rate of pressure release.

The arrangement 200, thus, slowly allows the pneumatic actuator 202 to relieve all of the retained pressure and enable the full bias force to be applied to close the valve 204 and create a seal with low through-valve-leakage. In this manner, the arrangement 200 provides for high integrity sealing but does not use higher sealing forces during high frequency cycling.

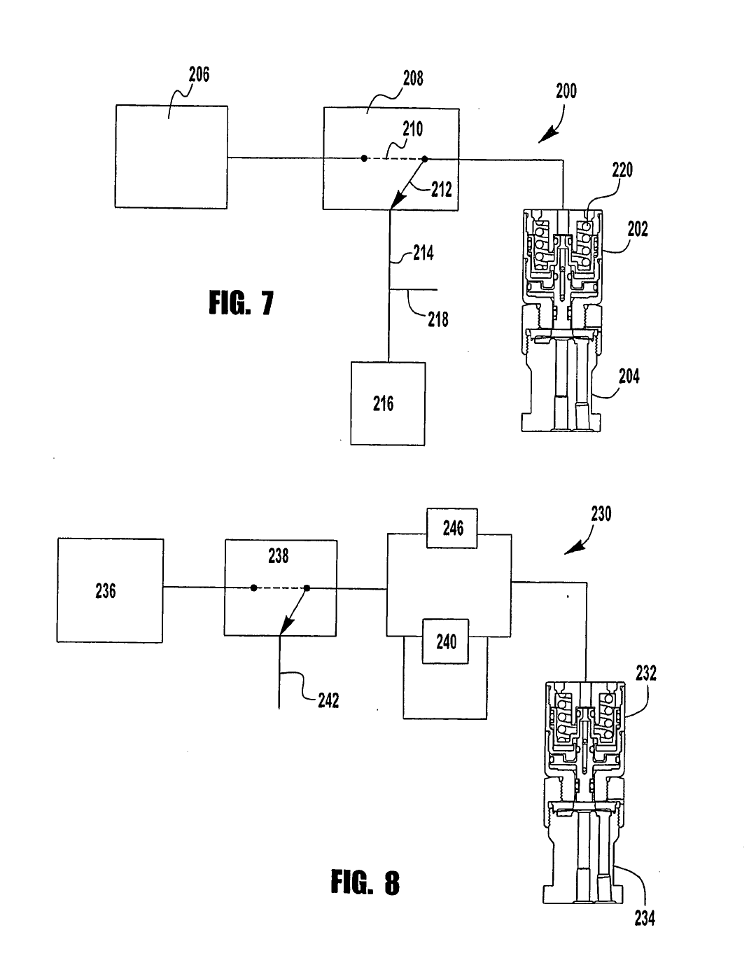

FIG. 8 schematically illustrates another exemplary embodiment of the arrangement. In this embodiment, the arrangement 230 includes an actuator 232, an actuated device 234, a pressure source 236, a switching device 238, a pressure retention device 240, and a vent path 242 that may be similar in design to the embodiment described in FIG. 7. Further, the arrangement 230 operates substantially similar to the arrangement 200 of FIG. 7. In this embodiment, however, the pressure retention device 240 is positioned between the switching device 238 and the actuator 232 and the leak path 244 is illustrated as a bypass around the pressure retention device 240. In addition, the arrangement may include a check valve 246 that prevents pressure in the actuator 246 to release through the check valve 246. The check valve 46 may also have a preset or user-adjustable cracking pressure, such as for example 5 psi.

As illustrated by the examples in FIGS. 7 and 8, the present invention may provide two or more outputs by providing or allowing for the application of a first amount of a force, such as for example, an actuation force or a closing force, while providing or allowing for the application of a different amount of that force. The examples of FIGS. 7 and 8 provide one level of output force when an input condition is changed and provide a second level of output force after a period of time following the change in the input condition.

In the examples of FIGS. 7 and 8, the change between the outputs is time dependent. In the examples of FIGS. 7 and 8, a different force is applied when the device remains in the second position for a predetermined amount of time. This may occur, for example, when a device is cycling in one mode of operation and is stationary in another mode of operation or when a device is operating in a at a first cycling frequency in one mode and operating at a second cycling frequency in a second mode.

The invention has been described with reference to the preferred embodiments. Modification and alterations will occur to others upon a reading and understanding of this specification. It is intended to include all such modifications and alterations insofar as they come within the scope of the appended claims or the equivalents thereof.

1. An actuator arrangement comprising:
a first piston assembly moveable between a first position and a second position; and
a second piston assembly moveable between a third position and a fourth position;
the second piston assembly being selectively movable between the third position and the fourth position when the first piston assembly is in the first position; and wherein the first piston assembly moves the second piston assembly to the fourth position when the first piston assembly moves to the second position.

2. The actuator arrangement of claim 1 further comprising a first biasing member for biasing the first piston towards the second position and a second biasing member for biasing the second piston towards the third position.

3. The actuator arrangement of claim 2 wherein the biasing force of the first biasing member is greater than the biasing force of the second biasing member.

4. The actuator arrangement of claim 1 further comprising at least one pressurizable chamber located proximate to the first piston assembly for biasing the first piston assembly toward the first position when pressurized.

5. The actuator arrangement of claim 1 further comprising at least one pressurizable chamber located proximate to the second piston assembly for biasing the second piston assembly toward the fourth position when pressurized.

6. The actuator arrangement of claim 1 wherein the second piston assembly is adapted to close a valve when in the fourth position.

7. An actuator arrangement comprising:
a first actuator; and
a second actuator engageable by the first actuator;
wherein the second actuator is capable of supplying a first amount of force independent of the first actuator;
and wherein the first actuator, acting through the second actuator, is capable of selectively supplying a second amount of force, which is greater than the first amount of force.

8. The actuator assembly of claim 7 further comprising at least one pressurizable chamber, wherein pressurizing the at least one pressurizable chamber selectively supplies the second amount of force.

9. The valve assembly of claim 7 wherein the first actuator comprises a first piston assembly movable within a first piston compartment to selectively engage and disengage a second piston assembly within the second actuator.

10. The valve assembly of claim 9 wherein fluid pressure moves the first piston assembly out of engagement with the second piston assembly in the first mode.

11. The valve assembly of claim 9 further comprising a first biasing member disposed proximate to the first piston assembly for biasing the first piston assembly into engagement with the second piston assembly.

12. The valve assembly of claim 11 further comprising a second biasing member disposed proximate to the second piston assembly for biasing the second piston assembly out of engagement with the sealing member.

13. A valve assembly, comprising:
a first actuator comprising:
a first housing portion defining a first compartment; and
a first piston assembly slideably disposed in the first compartment;
a second actuator engageable by the first actuator, the second actuator comprising:
a second housing portion coupled to the first housing portion, the second housing portion defining a second compartment; and
a second piston assembly slideably disposed in the second compartment;
a valve body assembled with the second actuator, the valve body defining a flow path, and
a sealing member engageable with the valve body to seal the flow path;
wherein the second actuator is capable of selectively applying a first amount of force, independent of the first actuator, to the sealing member to seal the flow path;
and wherein, the first actuator is capable of selectively applying a second amount of force, through the second actuator, to the sealing member to seal the flow path.

14. The valve assembly of claim 13 wherein the first piston assembly is movable between a first position and a second position, and wherein a first biasing member is disposed in the first compartment for biasing the first piston assembly to the second position.

15. The valve assembly of claim 14 wherein the second amount of force is generated by the first biasing member biasing the first piston assembly to the second position.

16. The valve assembly of claim 13 wherein the second piston assembly is movable between a third position and a fourth position, and wherein a second biasing member is disposed in the second compartment for biasing the second piston assembly to the third position.

17. The valve assembly of claim 13 where the second amount force is decreased by increasing the fluid pressure in at least one pressurizable chamber located proximate to the first piston assembly.

18. The valve assembly of claim 13 wherein the first amount of force is increased by increasing the fluid pressure in at least one pressurizable chamber located proximate to the second piston assembly.

19. The valve assembly of claim 13 wherein the sealing member is a diaphragm.

20. The valve assembly of claim 13 wherein the second amount of force is greater than the first amount of force.

21. A method of controlling a valve, comprising:
using a first amount of actuation force for closing the valve to control fluid flow through the valve; and
using a second amount of actuation force for maintaining the valve in a closed position;
wherein the first amount of actuation force is greater than the second amount of actuation force.

22. A method of claim 21 wherein the first amount of force is used to cycle the valve between an open position and a closed position.

23. The method of claim 22 wherein the first actuator movable member is capable of cycle the valve between an open position and a closed position in less than about 20 milliseconds.

24. A method of supplying output force from an actuator, comprising:
moving a first movable actuator member out of engagement with a second movable actuator member;
moving the second movable actuator member independent of the first moveable actuator member to supply a first amount force; and
moving the first movable actuator member into engagement with the second movable actuator member to move both the first and second movable actuator members to supply a second amount of force.

25. The method of claim 23 wherein the first amount of force is less than the second amount of force.

26. The method of claim 23 wherein the first actuator movable member is moved into engagement with the second actuator movable member by the biasing force of a spring.

27. The method of claim 23 wherein the first actuator movable member is moved out of engagement with a second actuator movable member by fluid pressure in a pressurizable chamber proximate the first actuator member.

28. A method of controlling an actuator, comprising:
providing a first amount of output force from the actuator in response to a first input signal; and
providing a second amount of output force from the actuator after a predetermined period of time after receiving the a first input signal.

29. The method of claim 28 wherein the second amount of output force from the actuator exceeds the first amount of output force.

30. The method of claim 28 wherein the input signal is a reduction in fluid pressure supplied to the actuator from a first amount to a second amount.

31. The method of claim 28 wherein providing a second amount of output force from the actuator after a predetermined period of time, comprises reducing the amount of pressure in the actuator from a second amount to a third amount

32. The method of claim 31 wherein the third amount is substantially zero.

33. A method of operating a pressure actuated device, comprising the steps of:
supplying a first amount of pressure to an actuator to move the device to a first position;
reducing the amount of pressure to a second amount to move the device to a second position; and
reducing the pressure from the second amount to a third amount while the device is generally maintained in the second position.

34. The method of claim 33 wherein the third amount of pressure is substantially zero.

35. The method of claim 33 wherein the actuated device comprises a valve and wherein the first position corresponds to the valve being open and the second position corresponds to the valve being closed.

36. An arrangement for operating an actuated device, comprising:
a pressure driven actuator adapted to cycle between a first position and a second position;
a pressure retention device for maintaining an amount of pressure in the actuator when the actuator is in the second position; and
a vent path capable of releasing pressure from the actuator maintained by the pressure retention device while the actuator remains in the second position.

37. The arrangement of claim 36 wherein a biasing element biases the actuator toward the first position.

38. The arrangement of claim 36 wherein the actuated device is a valve, the first position corresponds to the valve being open, and the second position corresponds to the valve being closed.

39. The arrangement of claim 36 wherein a pressure retention device comprises a check valve.

40. An arrangement for use with a high cycle frequency valve, the system comprising an actuator,
a pressure source capable of pressurizing the actuator;
a vent path capable of releasing pressure from the actuator;
a switching device for selectively placing the actuator in fluid communication with the pressure source and the vent path to move the actuator between a first and second position;
a pressure retention device for limiting the amount of pressure released from the actuator through the vent path; and
a leak path for releasing the pressure retained in the actuator by the pressure retention device.
